(19) United States
(12) Patent Application Publication
(10) Pub. No.: US 2011/0030372 A1
(43) Pub. Date: Feb. 10, 2011

(54) EGR APPARATUS FOR INTERNAL COMBUSTION ENGINE

(75) Inventors: Kiyoshi Ooshima, Anjo-city (JP); Etsugou Yanagida, Kariya-city (JP); Yoshitaka Nishio, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/852,735

(22) Filed: Aug. 9, 2010

(30) Foreign Application Priority Data
Aug. 10, 2009 (JP) 2009-185526
Jan. 26, 2010 (JP) 2010-14510

(51) Int. Cl. F02B 33/44

(52) U.S. Cl. 60/605.2

(57) ABSTRACT

A mixing device of an EGR apparatus has a double pipe structure being composed of a first cylindrical member and a second cylindrical member, wherein the first and second cylindrical members are coaxially arranged with each other. Cyclone blades are provided between the first and second cylindrical members, so that EGR gas introduced from an inlet portion into an inside of the first cylindrical member flows along an cylindrical inner wall of the first cylindrical member. A swirl flow is generated in the EGR gas passing through the cyclone blades, so that the EGR gas spirally flows in a downstream side to remove foreign material, such as flocculated water from the EGR gas.

### CROSS REFERENCE TO RELATED APPLICATION

This application is based on Japanese Patent Application No. 2009-185526 filed on Aug. 10, 2009 and No. 2010-014510 filed on Jan. 26, 2010, the disclosures of which are incorporated herein by reference.

### FIELD OF THE INVENTION

The present invention relates to an exhaust gas recirculation apparatus for an internal combustion engine.

### BACKGROUND OF THE INVENTION

Conventionally, EGR (Exhaust Gas Recirculation) technology is known in the art, according to which a part of exhaust gas is introduced from an exhaust pipe into intake air (fresh intake air) of an intake pipe so that the exhaust gas and fresh intake air is mixed and supplied into combustion chambers of an internal combustion engine. Recently, attention has been paid to the EGR technology in view of decrease of nitrogen oxides (NOx) and improvement of fuel consumption.

There are known two types of EGR systems. One of the EGR systems is called as HPL EGR (High Pressure Loop EGR), according to which a high pressure exhaust gas is introduced into a portion of an intake pipe in which intake air pressure is rather high. The other of the EGR systems is called as LPL EGR (Low Pressure Loop EGR), according to which a low pressure exhaust gas is introduced into another portion of the intake pipe in which intake air pressure is rather low. According to the HPL EGR, a part of the exhaust gas emitted from combustion chambers shortly after exhaust valves is introduced into a portion of an intake passage at a downstream side of a throttle valve and immediately before intake valves. However, since the intake air pressure of the portion into which the exhaust gas is re-circulated is rather high for such an engine having a supercharger, there is a limit for sufficiently introducing the exhaust gas into the fresh intake air. Therefore, the LPL EGR is used in addition to the HPL EGR, in order to realize sufficient amount of EGR.

According to the LPL EGR, exhaust gas having passed through a DPF (Diesel Particulates Filter) which is relatively low pressure is introduced into a portion of the intake passage at an upstream side of a compressor constituting a supercharger. However, there may be a problem that water contained in the exhaust gas would become flocculated water due to temperature decrease of the exhaust gas, and such flocculated water may have an adverse influence on the compressor rotating at high speed. In addition, a part of the DPF made of ceramic material may be broken. In such a case, foreign material may be contained in the exhaust gas, which would also give an adverse influence on the compressor rotating at high speed.

In order to solve the above problem, it is proposed, for example, as disclosed in Japanese Patent Publication No. 2009-041551, to generate swirl flow in the exhaust gas and to remove the flocculated water and other foreign material from the exhaust gas by such swirl flow.

According to the above prior art (JP No. 2009-041551), a first swirl flow (S1) for EGR gas is generated in a cylindrical space (42a) to trap flocculated water, and then a second swirl flow (S2) is generated in an annular space between an outer and an inner cylindrical pipes 44 and 45 to further trap flocculated water from the EGR gas. It is disadvantageous in that a structure of a device for trapping the flocculated water is larger in its size.

According to another prior art, for example, as disclosed in French Patent Publication No. 2 896 546, an EGR device is proposed to sufficiently introduce exhaust gas into fresh intake air. According to a device of this prior art, for example, as shown in FIG. 1b, an intake air pipe is divided into two parts and an annular space or opening (13) is formed between the two pipes (10). The annular space or opening (13) is covered by a housing (30), into which exhaust gas is supplied through a pipe (20), so that sufficient amount of exhaust gas may be re-circulated.

According to the above prior art (French Patent Publication No. 2 896 546), since the exhaust gas directly flows into the intake air pipe (10) through the annular space or opening (13), it may be difficult to equally mix the exhaust gas with the fresh intake air without deviation. It may be furthermore difficult to sufficiently mix the exhaust gas with the fresh intake air, depending on the amount of the exhaust gas to be re-circulated.

### SUMMARY OF THE INVENTION

The present invention is made in view of the above problems. It is an object of the present invention to provide an EGR apparatus for an internal combustion engine having a mixing device, so that exhaust gas from which foreign material is removed is mixed with fresh intake air. In the mixing device, the foreign material, such as flocculated water, is sufficiently removed from the exhaust gas through centrifugal separation. The mixing device of the invention is made smaller.

It is a further object of the present invention to provide a mixing device, according to which exhaust gas to be re-circulated can be sufficiently mixed with the fresh intake air without causing deviation.

According to a feature of the invention, an EGR apparatus for an internal combustion engine with a supercharger comprises a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device.

The mixing device has a first cylindrical member having an inlet portion for introducing the EGR gas into an inside of the first cylindrical member, the inlet portion being provided at a side portion of the first cylindrical member in such a way that an axis of the inlet portion is directed in a direction parallel to a tangential line of a cylindrical inner wall of the first cylindrical member so that the EGR gas flows along the cylindrical inner wall to generate a swirl flow for the EGR gas.

The mixing device further has a second cylindrical member, a part of which is provided within the first cylindrical member so that the second cylindrical member is coaxially arranged with the first cylindrical member.

The second cylindrical member has; a flow-in portion connected to the intake passage for introducing the fresh intake air into the second cylindrical member; a flow-out portion, at least a part of the flow-out portion being provided in the inside of the first cylindrical member at a downstream side of the flow-in portion; and a small-diameter portion formed between the flow-in portion and the flow-out portion so that the fresh intake air flows through the second cylindrical member.

The mixing device further has; an interflow portion formed at least one of the small-diameter portion and the flow-out portion, through which the EGR gas flows from the inside of the first cylindrical member into an inside of the second cylindrical member; and a separation space formed at a downstream end of the first cylindrical member, so that foreign material removed from the EGR gas through centrifugal separation is temporally pooled therein.

The inlet portion is provided in the first cylindrical member at such a position, at which the inlet portion is offset from the interflow portion in an axial direction of the first cylindrical member, so that direct hitting of the EGR gas to the interflow portion is avoided.

According to another feature of the invention, an EGR apparatus for an internal combustion engine with a supercharger comprises a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device.

The mixing device has; a first cylindrical member having an inlet portion for introducing the EGR gas into an inside of the first cylindrical member; a swirl flow generating portion for generating a swirl flow of the EGR gas introduced from the inlet portion into the inside of the first cylindrical member, so that the EGR gas spirally flows along an inner cylindrical wall of the first cylindrical member and flows in a downstream direction in the inside of the first cylindrical member; and a second cylindrical member, a part of which is provided within the first cylindrical member so that the second cylindrical member is coaxially arranged with the first cylindrical member.

The mixing device further has; a flow-in portion provided as a part of one of the first and the second cylindrical members and connected to the intake passage for introducing the fresh intake air into the second cylindrical member; a flow-out portion provided as a part of the second cylindrical member and partly provided in the inside of the first cylindrical member at a downstream side of the flow-in portion, so that the fresh intake air and the EGR gas for which the swirl flow is generated by the swirl flow generating portion flow into the flow-out portion; and an outlet portion formed in the first cylindrical member at a position away from the flow-out portion in an outward and radial direction and for discharging foreign material removed from the EGR gas through centrifugal separation out of the mixing device.

According to a further feature of the invention, an EGR apparatus for an internal combustion engine with a supercharger comprises a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device.

The mixing device has; a first cylindrical member having an inlet portion for introducing the EGR gas into an inside of the first cylindrical member; and a second cylindrical member, apart of which is provided within the first cylindrical member so that the second cylindrical member is coaxially arranged with the first cylindrical member to form a double pipe structure.

The mixing device further has; a flow-in portion provided as a part of the second cylindrical member and connected to the intake passage for introducing the fresh intake air into the second cylindrical member; a small-diameter portion provided as a part of the second cylindrical member, an inner diameter of the small-diameter portion being gradually decreased toward a downstream end thereof; and a flow-out portion provided as a part of the second cylindrical member and partly provided in the inside of the first cylindrical member, an inner diameter of an upstream end of the flow-out portion being equal to that of the downstream end of the small-diameter portion.

In the above mixing device, the flow-out portion has an interflow portion so that the fresh intake air and the EGR gas flow into the flow-out portion, and

the inlet portion is provided in the first cylindrical member at such a position, at which the inlet portion is offset from the interflow portion in an axial direction of the first cylindrical member, so that direct hitting of the EGR gas to the interflow portion is avoided.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing an EGR apparatus for an internal combustion engine having a mixing device according to the present invention;

FIG. 2 is a schematic cross sectional view showing the mixing device of a first embodiment of the invention;

FIG. 3 is a schematic cross-sectional view taken along a line III-III in FIG. 2;

FIG. 4 is a schematic cross sectional view showing the mixing device of a second embodiment of the invention;

FIG. 5 is a schematic cross sectional view showing the mixing device of a third embodiment of the invention;

FIG. 6 is a schematic cross-sectional view taken along a line VI-VI in FIG. 5;

FIG. 7 is a schematic cross sectional view showing the mixing device of a fourth embodiment of the invention;

FIG. 8 is a schematic side view showing the mixing device when viewed in a direction VIII shown in FIG. 7;

FIG. 9 is a schematic cross sectional view showing the mixing device of a fifth embodiment of the invention;

FIG. 10 is a schematic side view showing the mixing device when viewed in a direction X shown in FIG. 9;

FIG. 11 is a schematic cross sectional view showing the mixing device of a sixth embodiment of the invention;

FIG. 12 is a schematic side view showing the mixing device when viewed in a direction XII shown in FIG. 11;

FIG. 13 is a schematic cross sectional view showing the mixing device of a seventh embodiment of the invention;

FIG. 14 is a schematic side view showing the mixing device when viewed in a direction XIV shown in FIG. 13;

FIG. 15 is a schematic cross sectional view showing the mixing device of an eighth embodiment of the invention; and

FIG. 16 is a schematic cross sectional view showing the mixing device of a modification of the eighth embodiment of the invention.

### DETAILED DESCRIPTION OF THE PREFERRED EMBODIMENTS

### First Embodiment

Embodiments of the present invention will be explained with reference to the embodiments shown in the drawings.

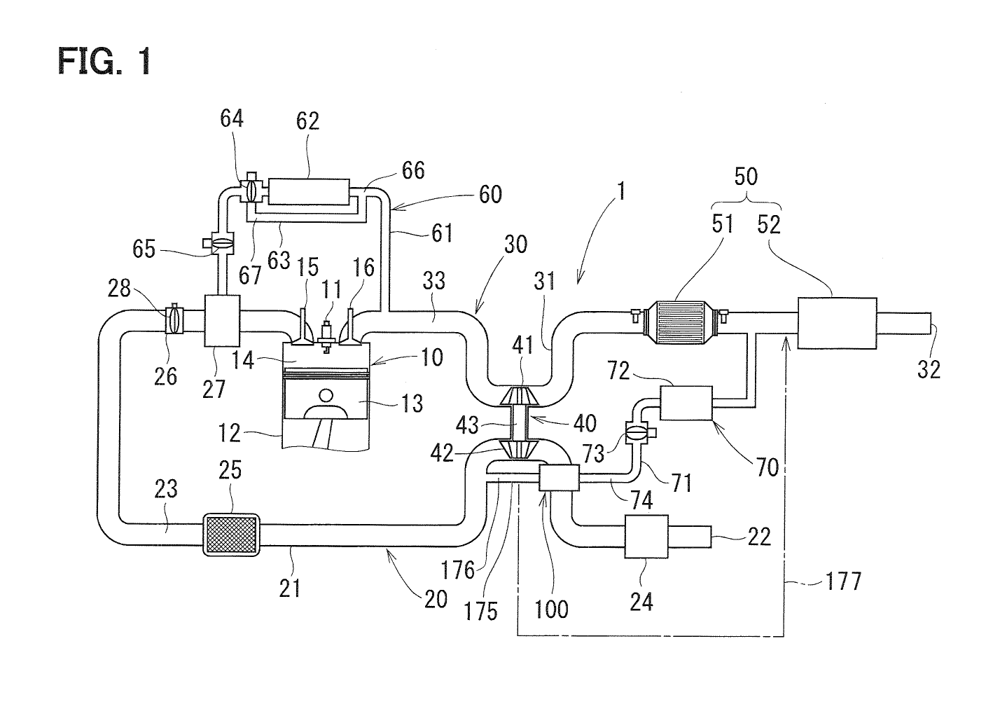

FIG. 1 schematically shows an EGR apparatus for an internal combustion engine (diesel engine) 1, which has an engine body 10, an intake system 20, an exhaust system 30, a supercharger 40, an exhaust gas purifying device 50, a HPL EGR device 60, a LPL EGR device 70 and a mixing device 100.

The engine body 10 has a glow plug 11, a cylinder 12 and a piston 13. The piston 13 is movably supported in the cylinder 12 so that it is reciprocated therein to form a combustion chamber 14 above the piston 13. Although the engine body 10 has multiple cylinders 12, one cylinder 12 is shown in the drawing. The engine body 10 further has an intake valve 15 and an exhaust valve 16.

The intake system 20 has an intake pipe 21. The intake pipe 21 has at one end an air inlet port 22 opening to the ambient air. The other end of the intake pipe 21 is connected to the engine body 10. The intake pipe 21 forms an intake passage 23 for connecting the air inlet port 22 with the combustion chamber 14 of the engine body 10. In the intake pipe 21, an air cleaner 24, an intercooler 25, a throttle device 26 and a surge tank 27 are provided in this order from an upstream side to a downstream side. A most downstream side of the intake pipe 21 is opened and/or closed by the intake valve 15.

The throttle device 26 has a throttle valve 28, which is a butterfly type valve for opening and/or closing the intake passage 23. As explained below, it is possible by the throttle valve 28 to adjust amount of EGR gas from the HPL EGR device 60. The surge tank 27 is provided at a downstream side of the throttle device 26. The intake air is distributed to the multiple combustion chambers 14 via the surge tank 27.

The exhaust system 30 has an exhaust pipe 31. The exhaust pipe 31 is connected at one end to the engine body 10. The other end of the exhaust pipe 31 is formed as an exhaust port 32 opening to the ambient air. The exhaust pipe 31 forms an exhaust passage 33 for connecting the combustion chambers 14 of the engine body 10 with the exhaust port 32.

The supercharger 40 has a turbine 41 and a compressor 42, which are connected by means of a shaft 43 so that the turbine 41 and compressor 42 rotate in a synchronized manner.

The turbine 41 is provided at an upstream side of the exhaust passage 33. The compressor 42 is provided in the intake passage 23 between the air cleaner 24 and the intercooler 25.

According to the above structure, when the turbine 41 is driven to rotate by the exhaust gas flowing through the exhaust passage 33 and thereby the compressor 42 is rotated in the synchronized manner, the intake air into the combustion chambers is supercharged. The intercooler 25 provided at the downstream side of the compressor 42 cools down the intake air, the temperature of which is increased by the compressor 42.

The exhaust gas purifying device 50, which has a DPF (Diesel Particulates Filter) 51 and a catalyst 52, is provided in the exhaust passage 33 at a downstream side of the turbine 41. The DPF 51 is made of ceramic material and formed in a honeycomb shape, so that the DPF traps particulate matter, such as grime, contained in the exhaust gas passing through the exhaust gas purifying device 50. The catalyst 52 is a so-called three-way catalyst for purifying CO, HC, NOx and so on contained in the exhaust gas.

The HPL EGR device 60 has a communication pipe 61, a cooling device 62, a bypass pipe 63, an opening-degree control valve 64 and a HPL EGR valve 65.

The communication pipe 61 forms a communication passage 66 for connecting the exhaust passage 33 and the intake passage 23 with each other. More exactly, the communication passage 66 is branched off from the exhaust passage 33 at an upstream side of the turbine 41 and connected to the surge tank 27 at a downstream side of the throttle device 26. According to the above structure, the HPL EGR device 60 re-circulates, as EGR gas, a part of the high pressure exhaust gas immediately emitted from the combustion chambers 14 into the portion of the intake passage downstream of the throttle device 26, at which the pressure is controlled at a high value due to the supercharger 40.

The cooling device 62 cools down the EGR gas flowing through the communication passage 66. The bypass pipe 63 forms a bypass passage 67, which is branched from the communication passage 66 on a side of the exhaust passage 33 and connected to the communication passage 66 on a side of the intake passage 23, so that the bypass passage 67 bypasses the cooling device 62.

The opening-degree controlling valve 64 is provided at a converging portion between the communication passage 66 and the bypass passage 67. The opening-degree controlling valve 64 controls the amount of EGR gas flowing through the communication passage 66 via the cooling device 62 as well as the amount of EGR gas flowing through the bypass passage 67. As a result of controlling the amounts of EGR gas respectively flowing through the communication and bypass passages 66 and 67, the temperature of the EGR gas is controlled.

The HPL EGR valve 65 is provided in the communication pipe 61 between the opening-degree controlling valve 64 and the intake passage 23. The HPL EGR valve 65 opens and/or closes the communication passage 66 to control the amount of the EGR gas, which is re-circulated from the exhaust passage 33 into the intake passage 23 via the communication passage 66. When the HPL EGR valve 65 is opened, the part of the exhaust gas discharged from the engine body 10 is re-circulated as the EGR gas into the intake passage 23 via the HPL EGR device 60.

The LPL EGR device 70 has a communication pipe 71, a cooling device 72, and a LPL EGR valve 73.

The communication pipe 71 forms a communication passage 74 for connecting the exhaust passage 33 and the intake passage 23 with each other. More exactly, the communication passage 74 is branched off from the exhaust passage 33 at a downstream side of the turbine 41, that is a portion of the exhaust passage 33 between the DPF 51 and the catalyst 52 of the exhaust gas purifying device 50, and connected to the intake passage 23 at an upstream side of the compressor 42, which constitutes the supercharger 40 in the intake system 20. According to the above structure, the LPL EGR device 70 re-circulates, as EGR gas, a part of the low pressure exhaust gas having passed through the turbine 41 and the DPF 51 into the portion of the intake passage 23, at which the intake air pressure is low.

The cooling device 72 cools down the EGR gas flowing through the communication passage 74. The LPL EGR valve 73 is provided in the communication passage 74 between the cooling device 72 and the intake passage 23. The LPL EGR valve 73 opens and/or closes the communication passage 74 to control the amount of the EGR gas, which is re-circulated from the exhaust passage 33 into the intake passage 23 via the communication passage 74. When the LPL EGR valve 73 is opened, the part of the exhaust gas discharged from the engine body 10 is re-circulated as the EGR gas into the intake passage 23 via the LPL EGR device 70.

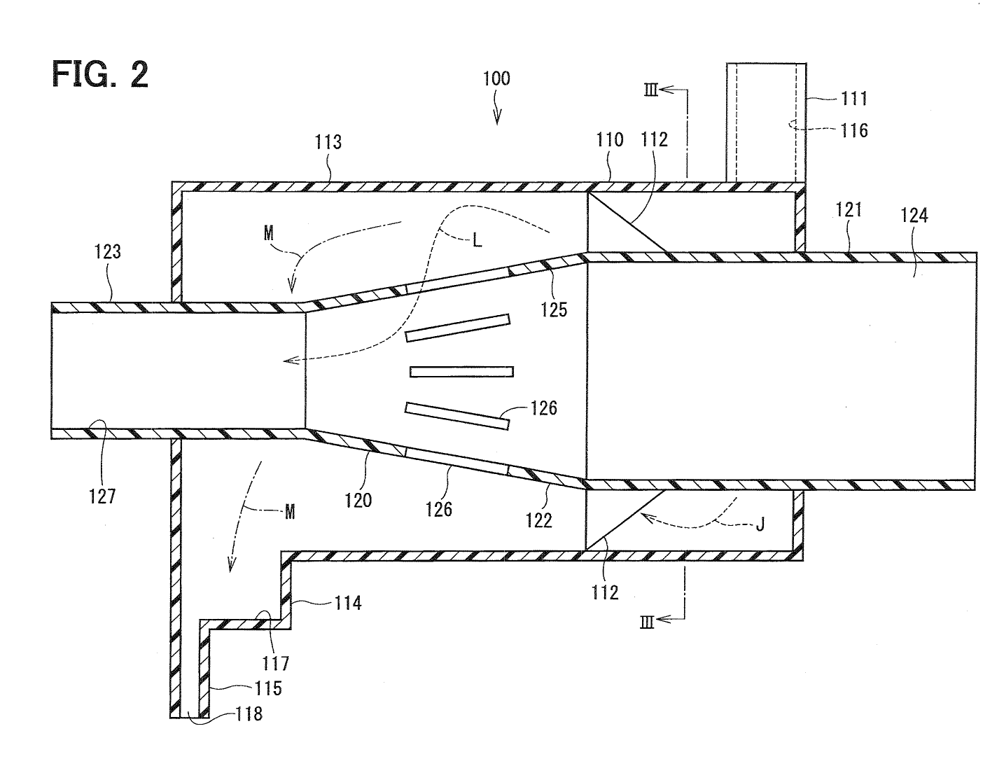

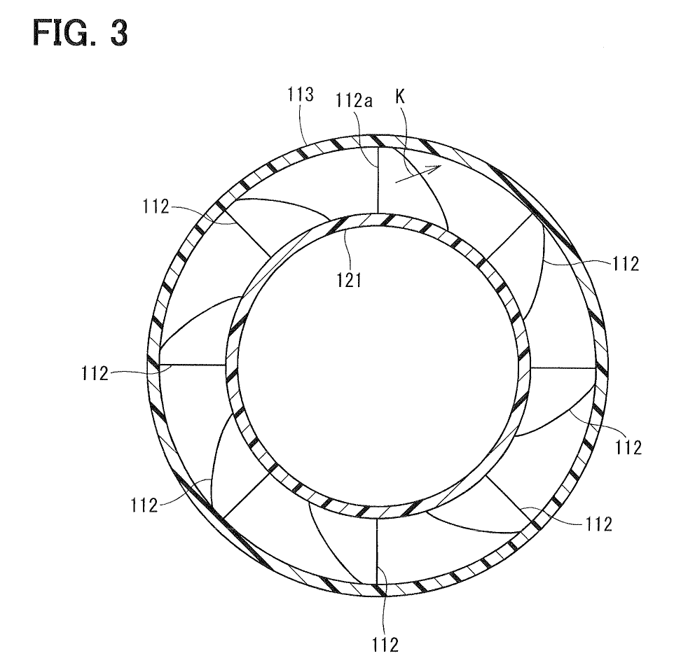

Now, the mixing device 100, which is one of characterizing portions of the invention, will be explained. The mixing device 100 is provided at a converging portion between the communication passage 74 and the intake passage 23. FIG. 2 is a schematic cross sectional view showing the mixing device 100, when viewed on a cross sectional surface which is in parallel to a longitudinal direction of the mixing device 100. FIG. 3 is a cross sectional view taken along a line in FIG. 2.

As shown in FIG. 2, the mixing device 100 has an outer cylindrical member 110 and an inner cylindrical member 120, each of which is made of resin. Each of the outer and inner cylindrical members 110 and 120 is also referred to as a first cylindrical member and a second cylindrical member.

The outer cylindrical member 110 has a cylindrical shape having an axis extending in a right-left direction in FIG. 2. The inner cylindrical member 120 is formed in a cylindrical shape, which is coaxial with the outer cylindrical member 110 and has a smaller diameter than the outer cylindrical member 110, so that the inner cylindrical member 120 penetrates the outer cylindrical member 110 in the axial direction thereof. The mixing device 100 is formed in a double-pipe structure.

The inner cylindrical member 120 forms a part of the intake passage 23 and is composed of a flow-in portion 121, a small-diameter portion (also referred to as a tapered portion) 122, and a flow-out portion 123 in a direction from an upstream side (a right-hand side) toward a downstream side (a left-hand side).

The flow-in portion 121 forms a flow-in passage 124, into which the fresh intake air flows from the intake passage 23. The small-diameter portion 122 is connected to the flow-in portion 121 and has an inner diameter which is gradually decreased toward the downstream side. The small-diameter portion 122 forms a small-diameter passage (also referred to as a tapered passage) 125. Multiple interflow windows 126 are formed at a side wall of the small-diameter portion 122, wherein the multiple interflow windows 126 are arranged in a circumferential direction of the tapered portion 122 at equal distances. The interflow windows 126 are long holes formed at the tapered portion 122, each of which is extending in an axial direction of the inner cylindrical member 120. The flow-out portion 123 is connected to a downstream side of the tapered portion 122, wherein the flow-out portion 123 forms a flow-out passage 127. The compressor 42 is provided at the downstream side of the flow-out passage 127.

The outer cylindrical member 110 has an inlet portion 111, multiple cyclone blades 112, a main body portion 113, a separating portion 114, and an outlet portion 115 in a direction from an upstream side (a right-hand and upper side) toward a downstream side (a left-hand and lower side).

The inlet portion 111 introduces the EGR gas from the LPL EGR device 70 into the mixing device 100. The inlet portion 111 is formed in a pipe shape and provided at a side portion of the outer cylindrical member 110. An axis of the inlet portion 111 is directed in a direction parallel to a tangential line of a cylindrical wall of the outer cylindrical member 110, so that the inlet portion 111 forms an inlet passage 116 directed to the tangential line of the cylindrical wall of the outer cylindrical member 110. As a result, the EGR gas introduced from the inlet passage 116 flows along an inner peripheral surface of the cylindrical wall of the outer cylindrical member 110, namely the swirl flow is generated in the flow of the EGR gas which is introduced into the outer cylindrical member 110 from the inlet passage 116, and the swirled flow is directed toward the cyclone blades 112, as indicated by an arrow J in FIG. 2.

As shown in FIG. 2, the inlet portion 111 is provided in the outer cylindrical member 110 at such a position, at which the inlet portion 111 is offset from the interflow windows 126 in an axial direction of the outer cylindrical member 110, so that direct hitting of the EGR gas to the interflow windows 126 is avoided.

Each of the cyclone blades 112 is connected to both of the inner peripheral wall of the outer cylindrical member 110 and an outer peripheral wall of the inner cylindrical member 120. As shown in FIG. 3, the multiple cyclone blades 112 are provided at equal distances in a circumferential direction. As shown in FIG. 3, each of the cyclone blades 112 is inclined with respect to the axial direction of the inner cylindrical member 120 toward the downstream side, for example as indicated by an arrow K for the cyclone blade 112a, which is located at a top of the drawing of FIG. 3. As a result, the flow of the EGR gas hitting on the cyclone blades 112 forms the swirl flow, so that the EGR gas spirally flows toward the downstream side in an annular space formed between the outer and inner cylindrical members 110 and 120, as indicated by an arrow L in FIG. 2. Accordingly, the foreign material, such as flocculated water, is properly separated from the EGR gas through the centrifugal separation. The EGR gas swirling outside of the inner cylindrical member 120 flows into the inside of the inner cylindrical member 120 through the interflow windows 126. The EGR gas is mixed with the fresh intake air and supplied into the compressor 42, which is located at the downstream side of the mixing device 100, through the flow-out passage 127.

The cyclone blades 112 (also referred to as a swirl flow generating portion) may be formed at least by a part of wall of the outer or inner cylindrical member 110 or 120, wherein the part of the wall extends in a radial and outward direction from the outer or inner cylindrical member.

The main body portion 113 is formed in a cylindrical shape covering the inner cylindrical member 120. The separating portion 114 is formed at a downstream end of the main body portion 113, in such a way that the separating portion projects outwardly from a side wall of the main body portion 113. The main body portion 113 has a separation space 117, in which the foreign material separated from the EGR gas is temporally pooled. As above, the foreign material removed from the EGR gas through the centrifugal separation is swirled along the inner peripheral wall of the main body portion 113 and flows into the separation space 117, as indicated by arrows M in FIG. 2. The outlet portion 115 forms an outlet passage 118, so that the foreign material pooled in the separation space 117 may be discharged through the outlet passage 118.

The outlet portion 115 is connected to a discharge pipe 175, as shown in FIG. 1, so that the foreign material is discharged, through a discharge passage 176, into the intake passage 23 at a downstream side of the compressor 42. Alternatively, the foreign material may be discharged into the exhaust passage 33 at the upstream side of the catalyst 52, as indicated by a one-dot-chain line 177 in FIG. 1.

As explained above, according to the mixing device 100 of the first embodiment of the present invention, the exhaust gas hitting on the cyclone blades 112 forms the swirl flow, which flows spirally in the downstream direction, so that the foreign material, such as the flocculated water, may be properly removed by the centrifugal separation.

Namely, by providing the cyclone blades 112, the EGR gas is forcibly swirled along the inner peripheral wall of the outer cylindrical member 110 in a spiral form. As a result, it becomes possible to sufficiently remove the foreign material (the flocculated water) through the centrifugal separation, and the smaller sized mixing device can be realized.

In addition, according to the mixing device 100 of the first embodiment, the fresh intake air can be supplied in the downstream direction without generating the swirl. Compared with a case in which the swirl is generated in the intake air, it is possible in the present embodiment that pressure loss can be suppressed as much as possible.

In addition, since the multiple cyclone blades 112 are provided at equal distances in the circumferential direction, it is simple in structure to generate the swirl flow for the EGR gas. In addition, each of the cyclone blades 112 is connected to both of the outer peripheral wall of the inner cylindrical member 120 and the inner peripheral wall of the outer cylindrical member 110. It is advantageous in view of mechanical strength for the mixing device.

Furthermore, according to the mixing device 110, the axis of the inlet port 111 is directed to the tangential line of the cylindrical wall of the outer cylindrical member 110. The EGR gas introduced from the inlet passage 116 is swirled along the inner peripheral wall of the outer cylindrical member 110 and directed toward the multiple cyclone blades 112, as indicated by the arrow J in FIG. 2. As a result, the strong swirl flow is generated to thereby make it possible to sufficiently separate the foreign material from the exhaust gas by the centrifugal separation.

### Second Embodiment

A second embodiment is different from the first embodiment in a structure of the mixing device. A mixing device 200 is applied to the engine 1 of FIG. 1 in place of the mixing device 100 of the first embodiment. The same reference numerals are used for those parts and components which are identical or similar to those of the first embodiment.

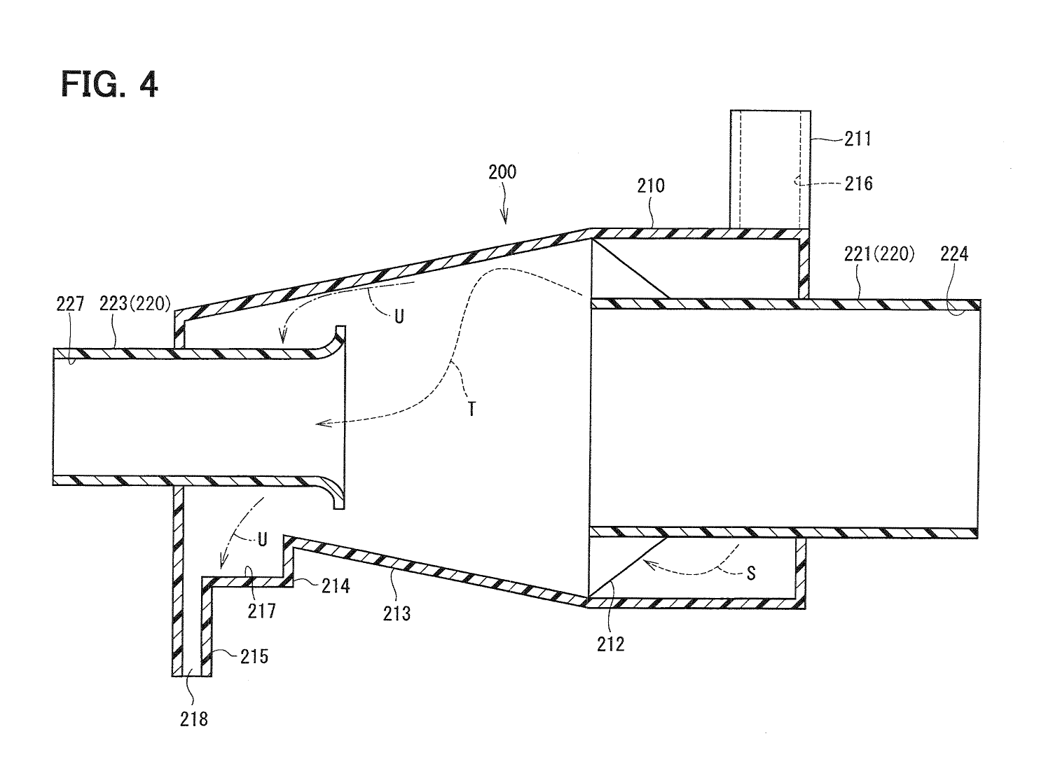

As shown in FIG. 4, the mixing device 200 has a first cylindrical member 210, a flow-in portion 221 inserted into the cylindrical member 210 in an axial direction thereof, and a flow-out portion 223 also inserted into the first cylindrical member 210. The flow-in portion 221 and the flow-out portion 223 form a second cylindrical member (220).

The flow-in portion 221 forms a flow-in passage 224, into which the fresh intake air flows from the intake passage 23. A downstream end of the flow-in portion 221 is opened to an inside of the cylindrical member 210. The flow-out portion 223 is made smaller in diameter than the flow-in portion 221 and forms a flow-out passage 227. A downstream side of the flow-out portion 223 is connected to the compressor 42, so that mixture of the EGR gas and the fresh intake air are supplied together to the compressor 42 through the flow-out passage 227. An upstream end of the flow-out portion 223 is opened to the inside of the cylindrical member 210 and its opening end is formed in a trumpet shape, namely its forward end is enlarged.

The first and second cylindrical members 210 and 220 form double pipe portions, namely at a portion between the cylindrical member 210 and the flow-in portion 221 and at a portion between the cylindrical member 210 and the flow-out portion 223. The cylindrical member 210 has an inlet portion 211, cyclone blades 212, a main body portion 213, a separating portion 214 for forming a separation space 217, and an outlet portion 215 for forming an outlet passage 218, in a direction from an upstream side (a right-hand and upper side) toward a downstream side (a left-hand and lower side). The structure of the first cylindrical member 210 is basically the same to that of the first embodiment and explanation thereof is omitted.

According to the above structure, the EGR gas introduced from the inlet passage 216 flows along an inner peripheral surface of the cylindrical wall of the cylindrical member 210, namely the swirl flow is generated in the flow of the EGR gas which is introduced into the cylindrical member 210 from the inlet passage 216, and the swirled flow is directed toward the cyclone blades 212, as indicated by an arrow S in FIG. 4. The EGR gas hitting on the cyclone blades 212 forms the swirl flow, which flows spirally in the downstream direction, as indicated by an arrow T in FIG. 4. As a result, the foreign material, such as the flocculated water, may be properly removed by the centrifugal separation. The EGR gas, from which the foreign material is removed, is swirled and mixed with the fresh air (intake air) and supplied to the compressor 42 through the flow-out passage 227. The foreign material removed from the EGR gas through the centrifugal separation is swirled along the inner peripheral wall of the main body portion 213 and flows into the separation space 217, as indicated by arrows U in FIG. 4. Then, the foreign material pooled in the separation space 217 may be discharged through the outlet passage 218.

In the above first embodiment, the interflow windows 126 are formed in the tapered portion 122, so that the EGR gas is mixed with the fresh intake air. According to the second embodiment, each of the downstream end of the flow-in portion 221 and the upstream end of the flow-out portion 223 is opened to the inside of the cylindrical member 210. With such an arrangement, the same effect to the first embodiment can be obtained.

In addition, according to the second embodiment, since the tapered portion for the first embodiment is not provided, the structure of the mixing device 200 can be made much simpler. Furthermore, a diameter of the main body portion 213 of the cylindrical member 210 is gradually reduced toward the downstream side. This makes it further possible to realize miniaturization of the mixing device.

### Third Embodiment

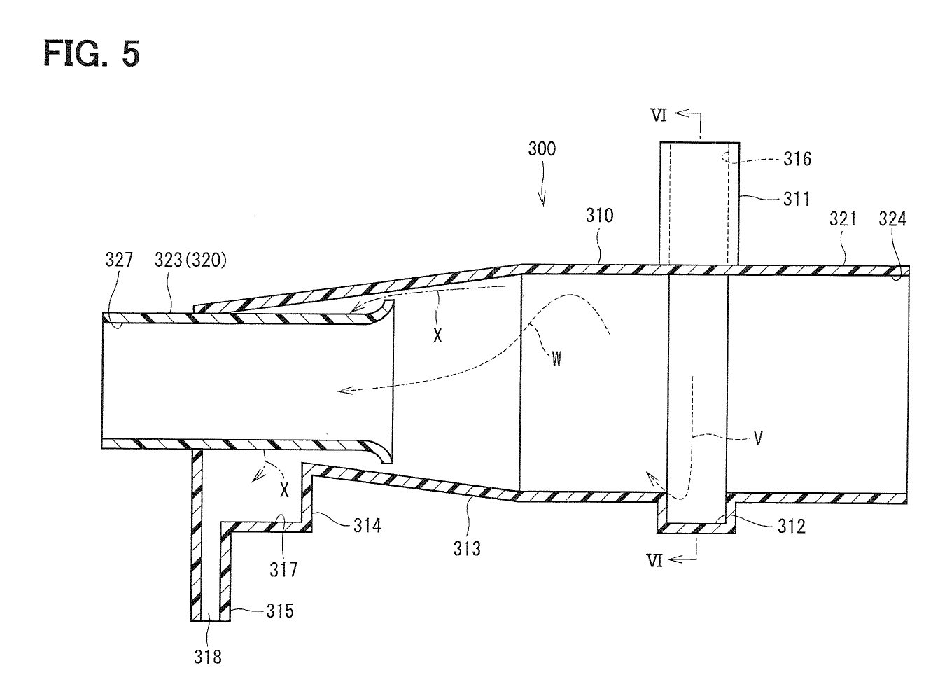

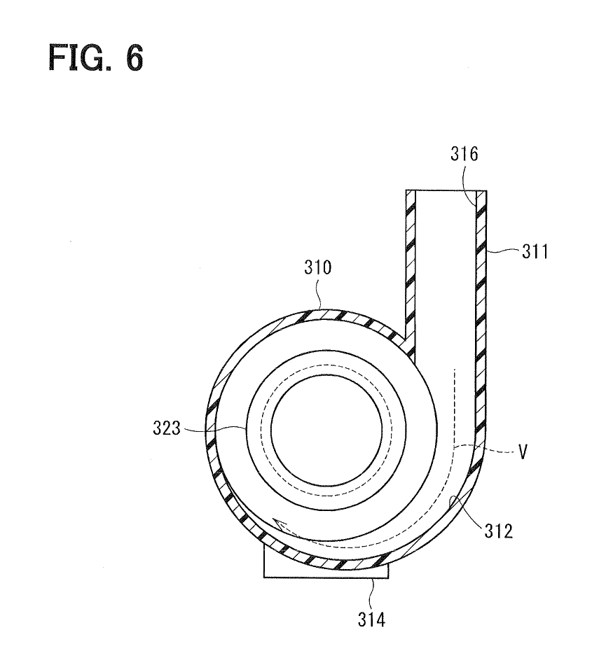

A third embodiment is different from the first and second embodiments in a structure of a mixing device. The structure of the mixing device 300 of the third embodiment will be explained with reference to FIGS. 5 and 6. FIG. 6 is a cross sectional view taken along a line VI-VI in FIG. 5.

As shown in FIG. 5, the mixing device 300 has a first cylindrical member 310, a flow-in portion 321 forming an upstream portion of the cylindrical member 310, and a flow-out portion 323 inserted into the cylindrical member 310 in an axial direction of the cylindrical member 310. The flow-out portion 323 forms a second cylindrical member (320).

The flow-in portion 321 forms a flow-in passage 324, into which the fresh intake airflows from the intake passage 23. The flow-out portion 323 is made smaller in diameter than the flow-in portion 321 and forms a flow-out passage 327. A downstream side of the flow-out portion 323 is connected to the compressor 42, so that mixture of the EGR gas and the fresh intake air are supplied together to the compressor 42 through the flow-out passage 327. An upstream end of the flow-out portion 323 is opened to the inside of the cylindrical member 310 and its opening end is formed in a trumpet shape, namely its forward end is enlarged.

The first and second cylindrical members 310 and 320 form a double pipe portion between the cylindrical member 310 and the flow-out portion 323.

The cylindrical member 310 has an inlet portion 311 forming an inlet passage 316, a swirl generating groove 312, a main body portion 313, a separating portion 314 for forming a separation space 317, and an outlet portion 315 for forming an outlet passage 318, in a direction from an upstream side (a right-hand and upper side) toward a downstream side (a left-hand and lower side).

The swirl generating groove 312 is formed by outwardly protruding a part of a cylindrical wall of the cylindrical member 310 in a radial direction. As shown in FIG. 6, a depth of the swirl generating groove 312 gradually becomes shallower, as a distance of the swirl generating groove 312 from the inlet port 311 becomes larger. A swirl flow of the EGR gas, in which a spiral flow of the EGR gas directed in the downward direction, is generated by the swirl generating groove 312, as schematically indicated by an arrow V in FIGS. 5 and 6. The other portions of the mixing device 300 are basically the same to those of the mixing device 200 of the second embodiment. The explanation thereof is omitted.

According to the above structure, the EGR gas introduced from the inlet passage 316 flows through the swirl generating groove 312 and the swirl flow of the EGR gas, in which the spiral flow of the EGR gas directed in the downward direction, is generated, as indicated by the arrow V in FIGS. 5 and 6. As a result, the foreign material, such as the flocculated water, may be properly removed by the centrifugal separation. The EGR gas, from which the foreign material is removed, is swirled and mixed with the fresh intake air, as indicated by an arrow W in FIG. 5, and supplied to the compressor 42 through the flow-out passage 327. The foreign material removed from the EGR gas through the centrifugal separation is swirled along the inner peripheral wall of the main body portion 313 and flows into the separation space 317, as indicated by arrows X in FIG. 5. Then, the foreign material pooled in the separation space 317 may be discharged through the outlet passage 318.

With the above structure for the mixing device 300, the same effect to the first embodiment can be obtained.

In the above first and second embodiments, the swirl flow of the EGR gas is generated by the cyclone blades 112 or 212. However, according to the third embodiment, the swirl flow is generated by the swirl generating groove 312. The mixing device can be made simpler. In the case of the third embodiment, compared with the structure having the cyclone blades, it is not necessary to form a double pipe structure at the upstream side of the cylindrical member 310. It is possible to sufficiently suppress the size of the cylindrical member in the radial direction to a smaller amount. This contributes further to the miniaturization of the mixing device. Furthermore, since the diameter of the cylindrical member 310 is gradually reduced toward the downstream direction, it is also advantageous in view of the miniaturization.

### Fourth Embodiment

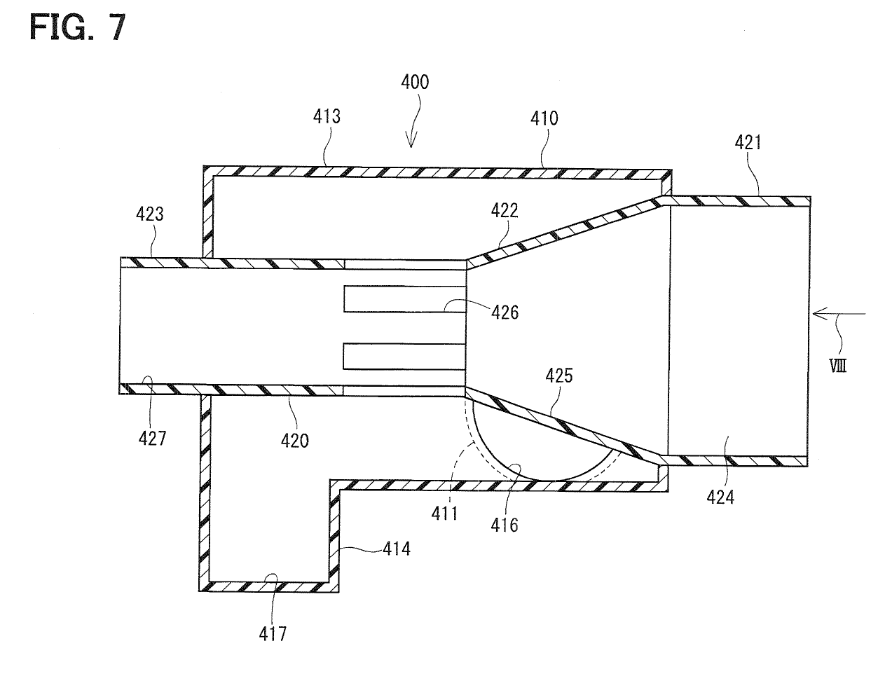

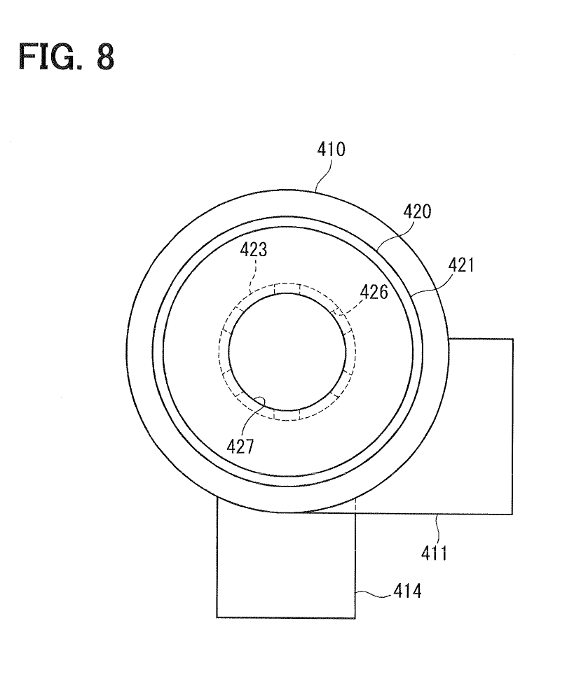

A fourth embodiment, which is similar to the first embodiment, will be explained with reference to FIGS. 7 and 8.

As shown in FIG. 7, a mixing device 400 has an outer cylindrical member 410 and an inner cylindrical member 420, each of which is made of resin. The outer and inner cylindrical members 410 and 420 are respectively referred to as a first cylindrical member and a second cylindrical member.

The outer cylindrical member 410 has a cylindrical shape having an axis extending in a right-left direction in FIG. 7. The inner cylindrical member 420 is formed in a cylindrical shape, which is coaxial with the outer cylindrical member 410 and has a smaller diameter than the outer cylindrical member 410, so that the inner cylindrical member 420 penetrates the outer cylindrical member 410 in the axial direction thereof. The mixing device 400 is formed in a double-pipe structure.

The inner cylindrical member 420 forms a part of the intake passage 23 and is composed of a flow-in portion 421, a small-diameter portion (also referred to as a tapered portion) 422, and a flow-out portion 423. Those portions are arranged in a direction from an upstream side (a right-hand side) toward a downstream side (a left-hand side).

The flow-in portion 421 forms a flow-in passage 424, into which the fresh air (intake air) flows from the intake passage 23. The small-diameter portion 422 is connected to the flow-in portion 421 and has an inner diameter which is gradually decreased toward the downstream side. The small-diameter portion 422 forms a small-diameter passage (also referred to as a tapered passage) 425. The flow-out portion 423 is connected to the small-diameter portion 422 and forms therein a flow-out passage 427. Multiple interflow windows 426 are formed at a side wall of the flow-out portion 423, wherein the multiple interflow windows 426 are arranged in a circumferential direction of the flow-out portion 422 at equal distances. The interflow windows 426 are long holes formed at the flow-out portion 422, each of which is extending in an axial direction of the inner cylindrical member 420. The compressor 42 of the supercharger 40 is provided at the downstream side of the flow-out passage 427, as shown in FIG. 1. An inner diameter of the flow-out portion 423 is designed to be equal to that of an inlet port of the supercharger 40. This feature may be also applied to the other embodiments.

The outer cylindrical member 410 has an inlet portion 411, a main body portion 413, a separating portion 414, and an outlet portion (not shown). Those portions are arranged in an order from an upstream side (a right-hand side) toward a downstream side (a left-hand and lower side) of the outer cylindrical member 410.

The inlet portion 411 introduces the EGR gas from the LPL EGR device 70 into the mixing device 400. The inlet portion 411 is formed in a pipe shape, an axis of which is directed to a tangential line of a cylindrical wall of the outer cylindrical member 410, so that the inlet portion 411 forms an inlet passage 416 directed to the tangential line of the cylindrical wall of the outer cylindrical member 410. However, the axis of the inlet passage 416 does not run through a center of the outer cylindrical member 410, as shown in FIG. 8. As a result, the EGR gas introduced from the inlet passage 416 flows along an inner peripheral surface of the cylindrical wall of the outer cylindrical member 410. A position of the inlet port 411 is overlapped with that of the small-diameter (tapered) portion 422 in the axial direction of the outer cylindrical member 410, so that direct hitting of the EGR gas onto the interflow windows 426 is avoided.

In other words, the inlet portion 411 is provided in the outer cylindrical member 410 at such a position, at which the inlet portion 411 is offset from the interflow windows 426 in the axial direction of the outer cylindrical member 410, so that direct hitting of the EGR gas to the interflow windows 426 is avoided.

The separating portion 414 is formed at a downstream end of the main body portion 413, in such a way that the separating portion projects outwardly in a radial direction from a side wall of the main body portion 413. The separating portion 414 forms a separation space 417, in which the foreign material separated from the EGR gas is temporally pooled. As above, the foreign material removed from the EGR gas through the centrifugal separation is swirled along the inner peripheral wall of the main body portion 413 of the cylindrical member 410 and flows into the separation space 417. The foreign material pooled in the separation space 417 may be discharged through the outlet passage (not shown).

According to the above fourth embodiment, the interflow windows 426 are formed at the flow-out portion 423, the inner diameter of which is the smallest among the other portions. Namely, the interflow windows 426 are formed at the flow-out portion 423, which has the same inner diameter to that of a downstream end of the tapered portion 422, so that the EGR gas flows into the flow-out passage 423 at such a position, where inner pressure is the lowest. As a result, the EGR gas can be sufficiently mixed with the fresh intake air. In addition, according to the fourth embodiment, the inlet portion 411 is arranged at such a position, at which the direct hitting of the EGR gas to the interflow windows 426 may be avoided. The EGR gas can be equally (without deviation) mixed with the fresh intake air.

Furthermore, according to the fourth embodiment, the inlet portion 411 is provided in such a way that the axis of the inlet portion 411 is in parallel to the tangential line of the cylindrical member 410, so that the EGR gas flows along the inner peripheral wall of the cylindrical member 410 to form the swirl flow. As a result, the foreign material, such as the flocculated water, may be properly removed by the centrifugal separation. The foreign material removed from the EGR gas through the centrifugal separation is swirled along the inner peripheral wall of the cylindrical member 410 and flows into the separation space 417. Therefore, the foreign material once removed from the EGR gas is suppressed from being mixed again with the EGR gas or the fresh intake air.

Furthermore, according to the fourth embodiment, the inner diameter of the flow-out portion 423 is made equal to that of the inlet port of the supercharger 40. It is, therefore, also possible to suppress pressure loss even at the downstream side of the mixing device 400. The inner diameter of the inlet port of the supercharger 40 is made to be smaller, because of restriction for the size of the compressor 42 and so on. In any event, it is necessary to make the inner diameter of the intake passage 23 smaller before the supercharger 40. According to the present embodiment, the small diameter passage (for the intake passage 23) is realized by the tapered portion 422 of the inner cylindrical member 420. Therefore, the mixing device 400 is advantageous in its economic structure.

### Fifth Embodiment

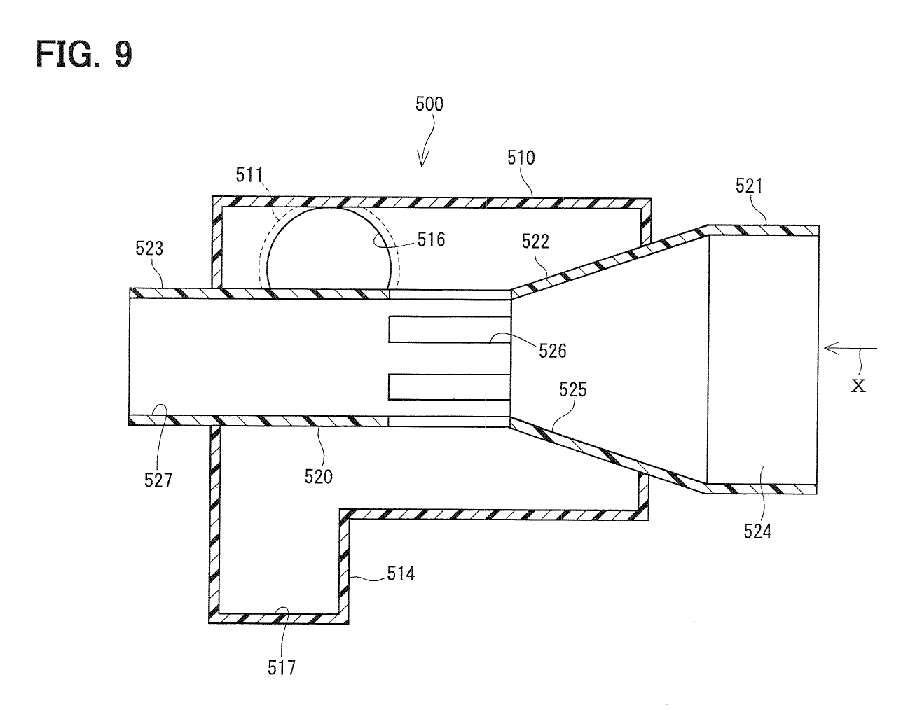

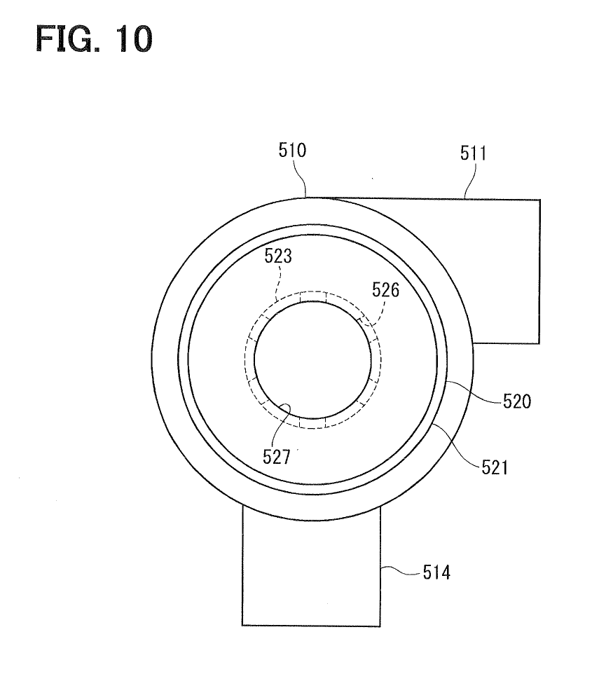

A fifth embodiment will be explained with reference to FIGS. 9 and 10, wherein the fifth embodiment is different from the other embodiments in a structure of the mixing device.

As shown in FIG. 9, a mixing device 500 of the fifth embodiment has an outer cylindrical member 510 and an inner cylindrical member 520, which is inserted into the outer cylindrical member 510 in an axial direction thereof. The outer and inner cylindrical members 510 and 520 are also referred to as a first and a second cylindrical member, respectively. The inner cylindrical member 520 has a flow-in portion 521, a small-diameter (tapered) portion 522, and a flow-out portion 523. The flow-in portion 521 forms a flow-in passage 524, the small-diameter portion 522 forms a small-diameter passage (tapered passage) 525, and the flow-out portion 523 forms a flow-out passage 527. The outer cylindrical member 510 has an inlet portion 511 for introducing the EGR gas into an inside of the outer cylindrical member 510 and a separating portion 514, which forms a separation space 517 opening to the inside of the outer cylindrical member 510.

The inlet portion 511 introduces the EGR gas from the LPL EGR device 70 into the mixing device 500. The inlet portion 511 is formed in a pipe shape and forms an inlet passage 516. An axis of the inlet passage 516 is directed to a tangential line of a cylindrical wall of the outer cylindrical member 510, but the axis of the inlet passage 516 does not run through a center of the outer cylindrical member 510, as shown in FIG. 10. As a result, the EGR gas introduced from the inlet passage 516 flows along an inner peripheral surface of the cylindrical wall of the outer cylindrical member 510.

A position of the inlet port 511 is overlapped with that of the flow-out portion 523 in the axial direction of the outer cylindrical member 510, so that direct hitting of the EGR gas onto the interflow windows 526 is avoided.

According to the fifth embodiment, the same or similar effects to the above embodiments may be obtained. In addition, since the inlet port 511 is located at a downstream side of the outer cylindrical member 510 which is close to the separation space 517, it is possible to properly remove the foreign material from the EGR gas through the centrifugal separation.

### Sixth Embodiment

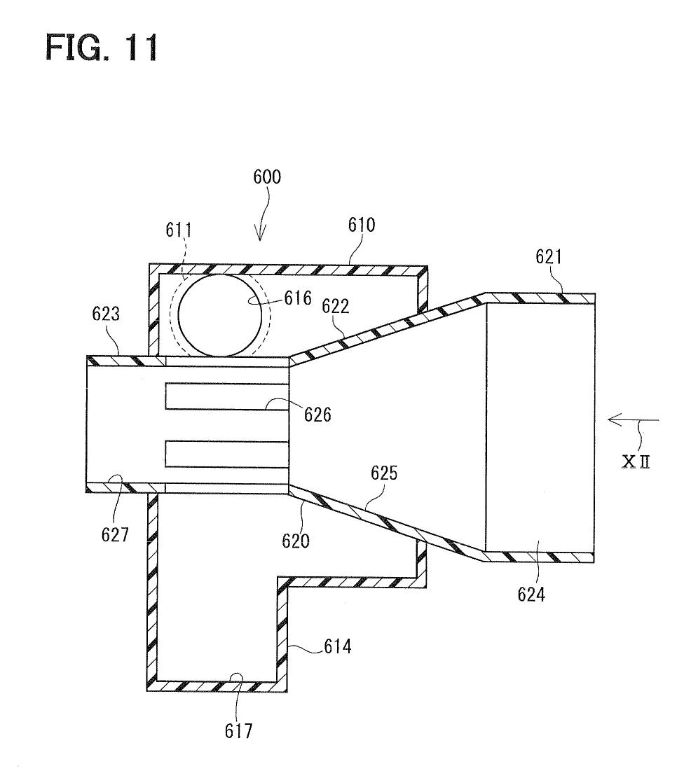

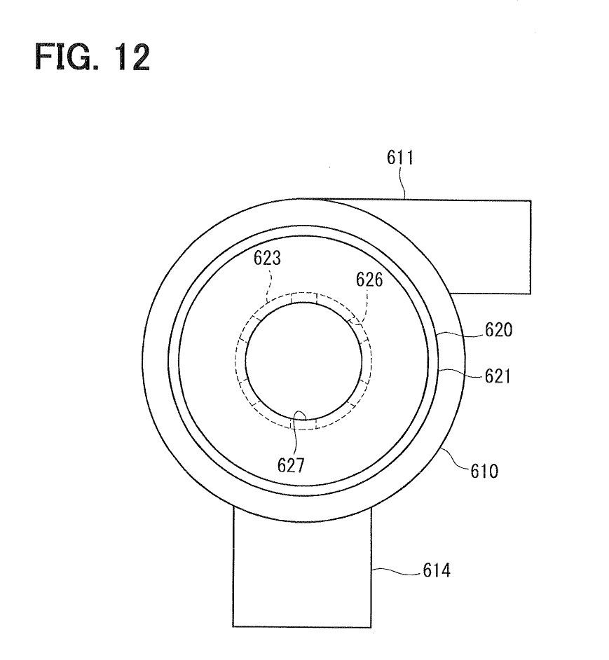

A sixth embodiment will be explained with reference to FIGS. 11 and 12, wherein the sixth embodiment is different from the other embodiments in a structure of the mixing device.

As shown in FIG. 11, a mixing device 600 of the sixth embodiment has an outer cylindrical member 610 and an inner cylindrical member 620, which is inserted into the outer cylindrical member 610 in an axial direction thereof. The outer and inner cylindrical members 610 and 620 are also referred to as a first and a second cylindrical member, respectively. The inner cylindrical member 620 has a flow-in portion 621, a small-diameter (tapered) portion 622, and a flow-out portion 623. The flow-in portion 621 forms a flow-in passage 624, the small-diameter portion 622 forms a small-diameter passage (tapered passage) 625, and the flow-out portion 623 forms a flow-out passage 627. As shown in FIG. 12, the outer cylindrical member 610 has an inlet portion 611 for introducing the EGR gas into an inside of the outer cylindrical member 610 and a separating portion 614, which forms a separation space 617 opening to the inside of the outer cylindrical member 610.

The inlet portion 611 introduces the EGR gas from the LPL EGR device 70 into the mixing device 600. The inlet portion 611 is formed in a pipe shape and forms an inlet passage 616. An axis of the inlet passage 616 is directed to a tangential line of a cylindrical wall of the outer cylindrical member 610, but the axis of the inlet passage 616 does not run through a center of the outer cylindrical member 610, as shown in FIG. 12. As a result, the EGR gas introduced from the inlet passage 616 flows along an inner peripheral surface of the cylindrical wall of the outer cylindrical member 610.

According to the sixth embodiment, the inlet port 611 is located at such a position, where the inlet port 611 is overlapped, in the axial direction of the outer cylindrical member 610, with interflow windows 626 formed at the flow-out portion 623 and the separation space 617. An inner diameter of the inlet passage 616 is made smaller in order that the EGR gas may not directly hit on the interflow windows 626.

According to the sixth embodiment, the same or similar effects to the above embodiments may be obtained. In addition, since the inlet port 611 is located at a downstream side of the outer cylindrical member 610 which is close to the separation space 617, it is possible to properly remove the foreign material from the EGR gas through the centrifugal separation.

### Seventh Embodiment

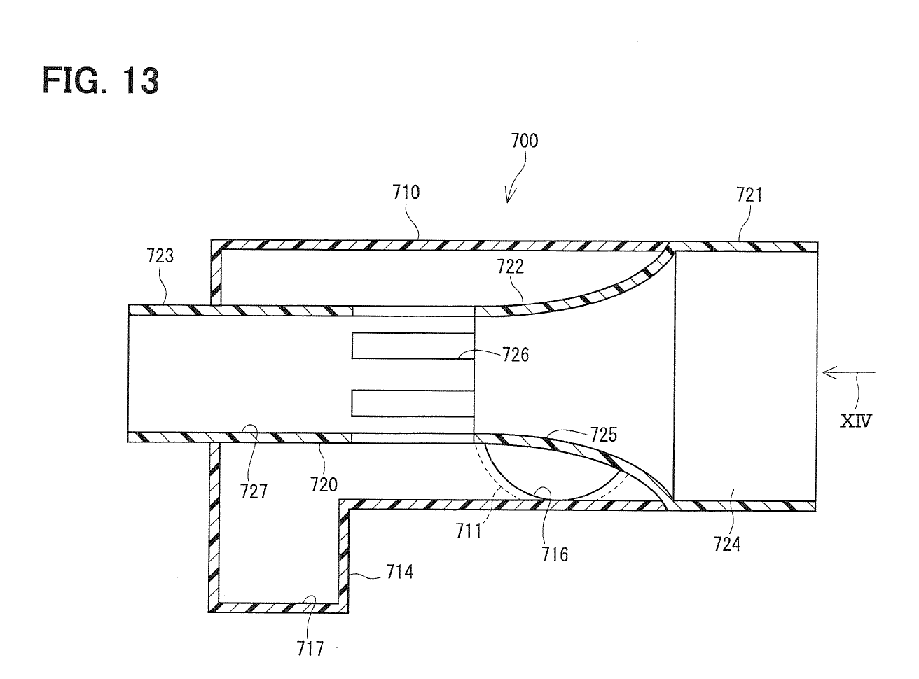

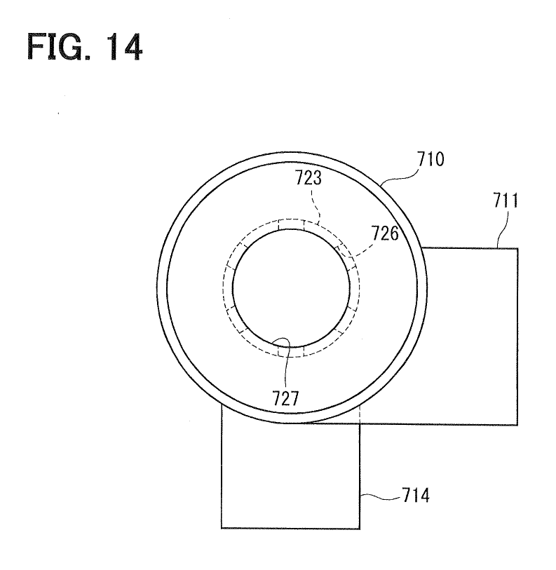

A seventh embodiment will be explained with reference to FIGS. 13 and 14, wherein the seventh embodiment is likewise different from the other embodiments in a structure of the mixing device.

As shown in FIG. 13, a mixing device 700 of the seventh embodiment has an outer cylindrical member 710 and an inner cylindrical member 720, a major portion of which is inserted into the outer cylindrical member 710. The outer and inner cylindrical members 710 and 720 are also referred to as a first and a second cylindrical member, respectively. The inner cylindrical member 720 has a flow-in portion 721, a small-diameter portion 722, and a flow-out portion 723. The flow-in portion 721 has an outer diameter and an inner diameter, each of which is identical to those of the outer cylindrical member 710. The flow-in portion 721 forms a flow-in passage 724, the small-diameter portion 722 forms a small-diameter passage 725, and the flow-out portion 723 forms a flow-out passage 727 at which multiple interflow windows 726 are formed. As shown in FIG. 14, the outer cylindrical member 710 has an inlet portion 711 for introducing the EGR gas into an inside of the outer cylindrical member 710, and a separating portion 714, which forms a separation space 717 opening to the inside of the outer cylindrical member 710.

The inlet portion 711 introduces the EGR gas from the LPL EGR device 70 into the mixing device 700. The inlet portion 711 is formed in a pipe shape and forms an inlet passage 716. An axis of the inlet passage 716 is directed to a tangential line of a cylindrical wall of the outer cylindrical member 710, but the axis of the inlet passage 716 does not run through a center of the outer cylindrical member 710, as shown in FIG. 14. As a result, the EGR gas introduced from the inlet passage 716 flows along an inner peripheral surface of the cylindrical wall of the outer cylindrical member 710. A position of the inlet port 711 is overlapped with that of the small-diameter (tapered) portion 722 in the axial direction of the outer cylindrical member 710, so that direct hitting of the EGR gas onto the interflow windows 726 is avoided.

As shown in FIG. 13, the small-diameter portion 722 has a curved surface, wherein the surface is convex inwardly (in a trumpet shape). A downstream end of the small-diameter portion 722 is smoothly connected to an upstream end of the flow-out portion 723.

In other words, the small-diameter portion 722 has a curved line in a cross-sectional surface, which is in parallel to an axial line of the small-diameter portion, wherein the curved line has a convex in an inward direction.

According to the seventh embodiment, the same or similar effects to the above embodiments may be obtained. Since the inner surface of the small-diameter portion 722 is formed in the convex shape in the inward direction, it is possible to suppress the pressure loss for the EGR gas when compared with the case in which the inner surface of the small-diameter portion is formed in a straight shape. In addition, since the downstream end of the small-diameter portion 722 is smoothly connected to the flow-out portion 723, the fresh intake air flows along the inner surface of the small-diameter portion 722, so that a so-called abruption of the fresh air can be avoided. As a result, the pressure loss of the fresh intake air can be also suppressed.

### Eighth Embodiment

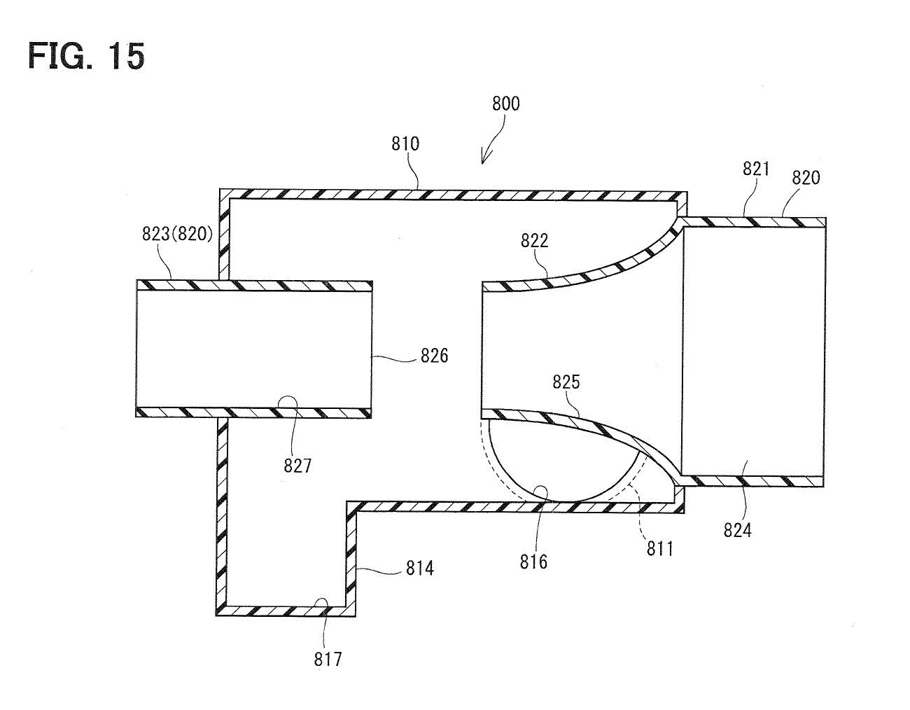

An eighth embodiment will be explained with reference to FIG. 15, wherein the eighth embodiment is likewise different from the other embodiments in a structure of the mixing device.

As shown in FIG. 15, a mixing device 800 of the eighth embodiment has an outer cylindrical member 810 and an inner cylindrical member 820, a part of which is inserted into the outer cylindrical member 810. The outer and inner cylindrical members 810 and 820 are also referred to as a first and a second cylindrical member, respectively. The inner cylindrical member 820 has a flow-in portion 821, a small-diameter portion 822, and a flow-out portion 823. The flow-in portion 821 forms a flow-in passage 824, the small-diameter portion 822 forms a small-diameter passage 825, and the flow-out portion 823 forms a flow-out passage 827. The outer cylindrical member 810 has an inlet portion 811 for introducing the EGR gas into an inside of the outer cylindrical member 810, and a separating portion 814, which forms a separation space 817 opening to the inside of the outer cylindrical member 810.

The inlet portion 811 introduces the EGR gas from the LPL EGR device 70 into the mixing device 800. The inlet portion 811 is formed in a pipe shape and forms an inlet passage 816. An axis of the inlet passage 816 is directed to a tangential line of a cylindrical wall of the outer cylindrical member 810, but the axis of the inlet passage 816 does not run through a center of the outer cylindrical member 810. As a result, the EGR gas introduced from the inlet passage 816 flows along an inner peripheral surface of the cylindrical wall of the outer cylindrical member 810. A position of the inlet port 811 is overlapped with that of the small-diameter (tapered) portion 822 in the axial direction of the outer cylindrical member 810.

As shown in FIG. 15, the small-diameter portion 822 has a curved surface, wherein the surface is convex inwardly (in a trumpet shape). At a downstream end of the small-diameter portion 822, a tangential line of the curved surface is directed in a direction parallel to the axial line of the small-diameter portion 822. The small-diameter portion 822 and the flow-out portion 823 are separated from each other but coaxially arranged with each other. An upstream end 826 of the flow-out portion is opened to the inside of the outer cylindrical member 801, so that the EGR gas and the fresh intake air are mixed with each other and such mixed gas flows into the flow-out portion 823 through the upstream-side open end 826 thereof.

According to the eighth embodiment, the same or similar effects to the above embodiments may be obtained. In addition, according to the present embodiment, since the inner surface of the small-diameter portion 822 is formed in the convex surface in the radial inward direction, it is possible to suppress the pressure loss for the EGR gas, when compared with the case in which the inner surface of the small-diameter portion is formed in a straight shape.

In addition, the tangential line of the curved surface at the downstream end of the small-diameter portion 822 is directed in parallel with the axial line of the inner cylindrical member 820. As a result, the fresh intake air flows along the inner wall of the small-diameter portion 822 and smoothly introduced into the flow-out passage 827. As a result, the pressure loss of the fresh intake air can be also suppressed.

### (Modification of Eighth Embodiment)

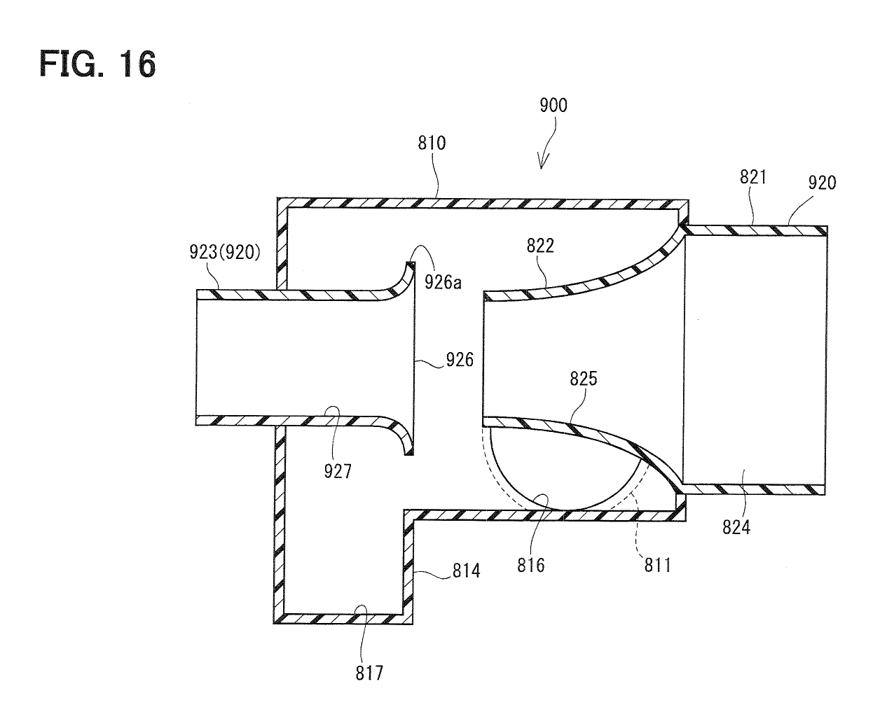

A modification of the eighth embodiment will be explained with reference to FIG. 16, wherein a structure of a flow-out portion 923 for a mixing device 900 is different from that of the mixing device 800 of the eighth embodiment (FIG. 15).

The flow-out portion 923 forms a flow-out passage 927, and the EGR gas and the fresh intake air is mixed and introduced into the flow-out passage 927 through an upstream-side open end 926 of the flow-out portion 923. The open end 926 is formed in a funnel shape, so that an outer periphery 926a of the open end 926 is extended in a radial outward direction. As a result, the EGR gas, which is swirling along the inner surface of the cylindrical member 810, may smoothly flow into the flow-out passage 927. According to the modification, in addition to the effects of the eighth embodiment, it is possible to suppress that the foreign material separated from the EGR gas and pooled in the separation space 817 may be mixed again with the fresh intake air and may flow into the flow-out passage 927 through the open end 926.

The present invention may not be limited to the above explained embodiments, but may be modified in various ways without departing from the spirit of the invention. For example,

(1) The mixing device of the above embodiments is applied to the diesel engine. However, the mixing device may be applied to a gasoline engine.

(2) The above mixing device is made of resin. However, the mixing device may be made of other material, such as metal, and so on.

What is claimed is:

1. An EGR apparatus for an internal combustion engine with a supercharger comprising:
a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device,
wherein the mixing device comprises;
a first cylindrical member having an inlet portion for introducing the EGR gas into an inside of the first cylindrical member, the inlet portion being provided at a side portion of the first cylindrical member in such a way that an axis of the inlet portion is directed in a direction parallel to a tangential line of a cylindrical inner wall of the first cylindrical member so that the EGR gas flows along the cylindrical inner wall to generate a swirl flow for the EGR gas;
a second cylindrical member, a part of which is provided within the first cylindrical member so that the second cylindrical member is coaxially arranged with the first cylindrical member;
a flow-in portion provided as a part of the second cylindrical member and connected to the intake passage for introducing the fresh intake air into the second cylindrical member;
a flow-out portion provided as another part of the second cylindrical member, at least a part of the flow-out portion being provided in the inside of the first cylindrical member at a downstream side of the flow-in portion;
a small-diameter portion formed between the flow-in portion and the flow-out portion so that the fresh intake air flows through the second cylindrical member;
an interflow portion formed at least one of the small-diameter portion and the flow-out portion, through which the EGR gas flows from the inside of the first cylindrical member into an inside of the second cylindrical member; and
a separation space formed at a downstream end of the first cylindrical member, so that foreign material removed from the EGR gas through centrifugal separation is temporally pooled therein,
wherein the inlet portion is provided in the first cylindrical member at such a position, at which the inlet portion is offset from the interflow portion in an axial direction of the first cylindrical member, so that direct hitting of the EGR gas to the interflow portion is avoided.

2. An EGR apparatus for an internal combustion engine with a supercharger comprising:
a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device,
wherein the mixing device comprises;
a first cylindrical member having an inlet portion for introducing the EGR gas into an inside of the first cylindrical member;
a swirl flow generating portion for generating a swirl flow of the EGR gas introduced from the inlet portion into the inside of the first cylindrical member, so that the EGR gas spirally flows along an inner cylindrical wall of the first cylindrical member and flows in a downstream direction in the inside of the first cylindrical member;
a second cylindrical member, a part of which is provided within the first cylindrical member so that the second cylindrical member is coaxially arranged with the first cylindrical member;
a flow-in portion provided as a part of one of the first and the second cylindrical members and connected to the intake passage for introducing the fresh intake air into the second cylindrical member;
a flow-out portion provided as a part of the second cylindrical member and partly provided in the inside of the first cylindrical member at a downstream side of the flow-in portion, so that the fresh intake air and the EGR gas for which the swirl flow is generated by the swirl flow generating portion flow into the flow-out portion; and
an outlet portion formed in the first cylindrical member at a position away from the flow-out portion in an outward and radial direction and for discharging foreign material removed from the EGR gas through centrifugal separation out of the mixing device.

3. The EGR apparatus according to the claim 2, wherein
the swirl flow generating portion is formed at least by a part of wall of the first or second cylindrical member, wherein the part of wall extends in a radial and outward direction from the first or second cylindrical member.

4. The EGR apparatus according to the claim 3, wherein
the part of wall forms multiple blades formed in a circumferential direction of the first cylindrical member at equal distances.

5. The EGR apparatus according to the claim 2, wherein
the swirl flow generating portion is formed as a groove provided at an inner wall of the first cylindrical member.

6. The EGR apparatus according to the claim 2, wherein
the inlet portion is opened to the inside of the first cylindrical member at an inner wall of the first cylindrical member so that the EGR gas flows along the inner wall and in a circumferential direction of the first cylindrical member.

7. The EGR apparatus according to the claim 2, wherein
the mixing device has a discharge pipe for connecting the outlet portion with the intake passage at a downstream side of the compressor.

8. The EGR apparatus according to the claim 2, wherein
the mixing device has a discharge pipe for connecting the outlet portion with an exhaust pipe at an upstream side of a catalyst for purifying the exhaust gas from the internal combustion engine.

9. An EGR apparatus for an internal combustion engine with a supercharger comprising:
a mixing device provided in an intake passage for the internal combustion engine at an upstream side of a compressor of the supercharger for mixing EGR gas, which is a part of exhaust gas emitted from the internal combustion engine, with fresh intake air flowing through the intake passage and supplied into the mixing device,
wherein the mixing device comprises;
a first cylindrical member having an inlet portion for introducing the EGR gas into an inside of the first cylindrical member;
a second cylindrical member, a part of which is provided within the first cylindrical member so that the second cylindrical member is coaxially arranged with the first cylindrical member to form a double pipe structure;
a flow-in portion provided as a part of the second cylindrical member and connected to the intake passage for introducing the fresh intake air into the second cylindrical member;
a small-diameter portion provided as a part of the second cylindrical member, an inner diameter of the small-diameter portion being gradually decreased toward a downstream end thereof; and
a flow-out portion provided as a part of the second cylindrical member and partly provided in the inside of the first cylindrical member, an inner diameter of an upstream end of the flow-out portion being equal to that of the downstream end of the small-diameter portion,
the flow-out portion having an interflow portion so that the fresh intake air and the EGR gas flow into the flow-out portion,
wherein the inlet portion is provided in the first cylindrical member at such a position, at which the inlet portion is offset from the interflow portion in an axial direction of the first cylindrical member, so that direct hitting of the EGR gas to the interflow portion is avoided.

10. The EGR apparatus according to the claim 9, wherein
the inlet portion is opened to the inside of the first cylindrical member at an inner wall of the first cylindrical member so that the EGR gas flows along the inner wall and in a circumferential direction of the first cylindrical member.

11. The EGR apparatus according to the claim 9, wherein
the mixing device further comprises a separation space opened to the inside of the first cylindrical member for pooling foreign material removed from the EGR gas.

12. The EGR apparatus according to the claim 11, wherein
the inlet portion is located at such a position, at which the inlet portion is overlapped with the separation space in an axial direction of the first cylindrical member.

13. The EGR apparatus according to the claim 9, wherein
the interflow portion comprises interflow windows formed at a wall of the flow-out portion.

14. The EGR apparatus according to the claim 9, wherein
the interflow portion comprises an upstream open end of the flow-out portion.

15. The EGR apparatus according to the claim 14, wherein
the upstream open end is formed in a funnel shape, so that a peripheral forward end is extending outwardly in a radial direction.

16. The EGR apparatus according to the claim 9, wherein
the small-diameter portion has a curved line in a cross-sectional surface, which is in parallel to an axial line of the small-diameter portion, wherein the curved line has a convex in an inward direction, and
a tangential line of the curved line at a downstream end of the small-diameter portion is in parallel to the axial line of the small-diameter portion.

17. The EGR apparatus according to the claim 9, wherein
an inner diameter of the flow-out portion, which is connected to the supercharger, is equal to an inlet port of the supercharger.
